(19) United States
(12) Patent Application Publication
(10) Pub. No.: US 2009/0235115 A1
(43) Pub. Date: Sep. 17, 2009

(54) DATA STORAGE

(75) Inventors: Stefan Butlin, Cambridge (GB); Hani Naguib, Solana Beach, CA (US)

Correspondence Address: BARNES & THORNBURG LLP, P.O. BOX 2786, CHICAGO, IL, 60690-2786, US

(73) Assignee: TAPTU LTD., Cambridge (GB)

(21) Appl. No.: 12/349,564

(22) Filed: Jan. 7, 2009

Related U.S. Application Data
(60) Provisional application No. 61/019,610, filed on Jan. 8, 2008.

(51) Int. Cl. G06F 11/14; G06F 12/00; G06F 12/02; G06F 13/00; G06F 12/16

(52) U.S. Cl. 714/8; 711/173; 711/162; 711/E12.001; 711/E12.103; 714/E11.113; 711/170

(57) ABSTRACT

A data storage system comprising a plurality of storage devices, each storage device comprising a plurality of storage nodes and each storage node comprising a plurality of logical partitions such that there are at least Q copies of a particular logical partition in the storage system. Each logical partition is divided into a plurality of sub-ranges which are individually lockable to both data input and data output whereby data in a particular logical partition is synchronisable sub-range by sub-range with the other copies of said particular logical partition. A method of maintaining such a data storage, including creating and updating data in the data store, recovering from failure of an element of the data store and/or increasing capacity in the data store.

### RELATED APPLICATIONS

This application claims the benefit of earlier filed provisional application Ser. No. 61/019,610 filed Jan. 8, 2008 entitled “Method of Recovering from Node Failure in Distributed Fault-tolerant Data Store”.

### FIELD OF THE INVENTION

This invention relates to data storage, including but not limited to databases which store material to provide a mobile search service.

### DESCRIPTION OF THE RELATED ART

Data storage systems are often required to be both scalable and fault-tolerant. A scalable storage system is one where the components implementing the system can be arranged in such a way that the total capacity available can be expanded by deploying additional hardware (typically consisting of servers and hard disks). In contrast, a non-scalable storage system would not be able to take advantage of additional hardware and would have capacity fixed at its originally deployed size. A fault tolerant storage system is one where the system can tolerate the software or hardware failure of a subset of its individual parts. Such tolerance typically involves implementing redundancy of those parts such that for any one part that fails, there is at least one other part still functioning and providing the same service. In other words, at least two replicas of each unit of data are stored on distributed hardware.

A key challenge to the implementation of these fault-tolerant systems is how to manage repair following a failure: if a unit of hardware such as a hard disk fails and its data is lost, the problem is how to resynchronise its data and bring it back online. An easy solution is to take the entire system offline and perform the synchronization of the replicas manually-safe in the knowledge that the surviving data is not being modified during this process. However, the obvious draw back to this approach is the required down-time which may not be permissible in some applications. So the challenge then becomes how to manage the repair following a failure whilst maintaining the live service. This challenge boils down to how to re-synchronise a replica of a unit of data whilst the surviving data continues to receive updates and thus complicate the re-synchronisation process.

A common solution to this problem is to use journaling: first a snapshot of the surviving data is made available to the recovery process, while the copying of the snapshot data proceeds, all new update (write/delete) requests are logged to a journal. When the copying of the snapshot has finished, the system is locked (all update requests are temporarily blocked) while the additional changes stored in the journal are replayed on to the newly copied data, thus bringing it completely up to date with the surviving data and all the changes that happened during the (presumably lengthy) snapshot copy process. The system can then be unlocked again and normal operation restored. However, the drawback to this approach is the need to implement the snapshot mechanism. As a result of this, either the data storage format itself needs to support fast snapshots or at least three replicas of the data are required such that in the face of one failure, one copy can continue to serve live requests and the second copy can be taken offline to serve as a static snapshot.

### SUMMARY OF THE INVENTION

According to one aspect there is provided a data storage system comprising a plurality of storage devices, each storage device comprising a plurality of storage nodes and each storage node comprising a plurality of logical partitions such that there are at least Q copies of a particular logical partition in the storage system, wherein each logical partition is divided into a plurality of sub-ranges which are individually lockable to both data input and data output whereby data in a particular logical partition is synchronisable sub-range by sub-range with the other copies of said particular logical partition.

Said particular logical partition may be a failed logical partition or a newly declared copy logical partition on a new, additional storage device. Each sub-range may be individually lockable in the sense that the subrange may be locked to read requests and/or or write requests or the sub-range may be made unavailable or by a combination of both locking and making unavailable.

According to another aspect there is provided a data storage system comprising a plurality of storage devices, each storage device comprising a plurality of storage nodes and each storage node comprising a plurality of logical partitions such that there are at least Q copies of a particular logical partition in the storage system, wherein each logical partition is divided into a plurality of sub-ranges which are individually lockable to both data input and data output whereby in the event of a failure of a logical partition, data is recoverable sub-range by sub-range in said failed logical partition from said copies of the failed logical partition.

According to another aspect there is provided a data storage system comprising a plurality of storage devices, each storage device comprising a plurality of storage nodes and each storage node comprising a plurality of logical partitions such that there are at least Q copies of a particular logical partition in the storage system, and at least one further storage device having a plurality of storage nodes with a plurality of logical partitions, wherein each logical partition is divided into a plurality of sub-ranges which are individually lockable to both data input and data output whereby data is synchronisable sub-range by sub-range between a logical partition in the at least one further storage device and corresponding copy logical partitions in the plurality of storage devices.

According to another aspect of the invention, there is provided a system for a user to store and retrieve data, said system comprising a storage system as described above and at least one user device connected to the storage system whereby when data is to be stored on the storage system said at least one user device is configured to input said data to an appropriate logical partition on said storage system and said storage system is configured to copy said data to all copies of said appropriate logical partition, and when data is to be retrieved on the storage system said at least one user device is configured to send a request to at least of the logical partitions storing said data to output said data from the storage system to the user device.

In other words, the present invention solves the live recovery process by arranging for incremental availability of recovering partitions without using journaling, snapshots or any system-wide locking. This is achieved by treating all partitions as collections of smaller partitions of varying data size, where each smaller partition is small enough to be resynchronized (copied) within a time period for which it is acceptable to block (delay) a fraction of the live write requests.

According to another aspect of the invention, there is a method of maintaining a fault-tolerant data storage system comprising providing a data storage system comprising a plurality of storage devices, each storage device comprising a plurality of storage nodes and each storage node comprising a plurality of logical partitions, configuring the plurality of logical partitions so that there are at least Q copies of any logical partition in the storage system, dividing each logical partition into a plurality of sub-ranges which are individually lockable to both data input and data output, whereby data in a particular logical partition is synchronisable sub-range by sub-range with the other copies of said particular logical partition.

Maintaining a data store may include creating and updating data in the data store, recovering from failure of an element of the data store and/or increasing capacity in the data store.

According to another aspect of the invention, there is a method of data recovery in a fault-tolerant storage system, said data storage system comprising a plurality of storage devices, each storage device comprising a plurality of storage nodes and each storage node comprising a plurality of logical partitions such that there are at least Q copies of any logical partition in the storage system and each logical partition is divided into a plurality of sub-ranges which are individually lockable to both data input and data output, the method comprising locking all sub-ranges of a failed logical partition, selecting a single sub-range of the failed logical partition to be synchronised, locking said selected single sub-range in all copies of said failed logical partition, synchronising data in said single sub-range of said failed logical partition with said single sub-range in all copies of said failed logical partition, unlocking said selected single sub-range in all copies of said failed logical partition, including said failed logical partition and repeating the selecting to unlocking steps until all sub-ranges are synchronised and unlocked.

According to another aspect of the invention, there is a method of increasing data storage in a fault-tolerant storage system comprising a plurality of storage devices, each storage device comprising a plurality of storage nodes and each storage node comprising a plurality of logical partitions such that there are at least Q copies of any logical partition in the storage system and each logical partition is divided into a plurality of sub-ranges which are individually lockable to both data input and data output, the method comprising locking all sub-ranges of said defined logical partition in said further storage device, selecting a single sub-range to be synchronised, locking said selected single sub-range in all copies of said defined logical partition, synchronising data in said single sub-range of said defined logical partition with said single sub-range in all copies of said defined logical partition, unlocking said selected single sub-range in all copies of said defined logical partition, including said defined logical partition and repeating the selecting to unlocking steps until all sub-ranges are unlocked.

The invention further provides processor control code to implement the above-described methods, in particular on a data carrier such as a disk, CD- or DVD-ROM, programmed memory such as read-only memory (Firmware), or on a data carrier such as an optical or electrical signal carrier. Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language). As the skilled person will appreciate such code and/or data may be distributed between a plurality of coupled components in communication with one another.

Various aspects of the invention are set out in the independent claims. Any additional features can be added, and any of the additional features can be combined together and combined with any of the above aspects. Other advantages will be apparent to those skilled in the art, especially over other prior art. Numerous variations and modifications can be made without departing from the claims of the present invention. Therefore, it should be clearly understood that the form of the present invention is illustrative only and is not intended to limit the scope of the present invention.

### BRIEF DESCRIPTION OF THE DRAWINGS

How the present invention may be put into effect will now be described by way of example with reference to the appended drawings, in which:

FIG. 1 shows schematically an overview of some of the complete system principal entities involved in an embodiment of the invention,

FIG. 2 shows a flowchart of the steps for storing data in the system shown in FIG. 1;

FIG. 3 shows a flowchart of the steps for reading data in the system shown in FIG. 1;

FIG. 4 shows a flowchart of the steps for the recovery of data in the system shown in FIG. 1;

FIG. 5 shows schematically an overview of some of the complete system principal entities involved in another embodiment of the invention;

FIG. 6 shows a flowchart of the steps for the transfer of data between entities in the system shown in FIG. 5; and

FIG. 7 is a schematic overview of a mobile search service which may implement the system of FIG. 1.

### DETAILED DESCRIPTION

### Detailed Description of the Drawings

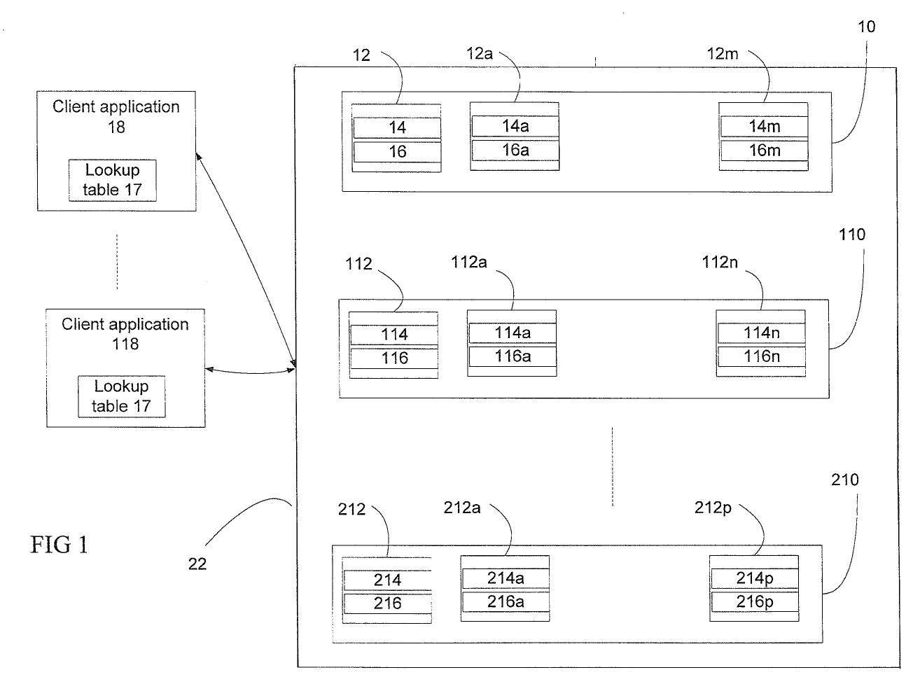

The overall topology is illustrated in FIG. 1 which shows a storage system 22 comprising a plurality of storage devices, namely server computers 10, 110, 210 each containing a plurality of storage nodes or disks (12, 12a, . . . 12m), (112, 112a, . . . , 112n), (212, 212a, . . . , 212p). There may be N servers and there may be the same number of disks on each server (i.e. m, n and p may equal M) or the number of disks on each server may be different. Each disk hosts a plurality of logical partitions (14, 16), (14a, 16a), (14m, 16m), (114, 116), (114a, 116a), (114n, 116n), (214, 216), (214a, 216a) and (214p, 216p). For convenience, only two logical partitions are depicted but there may be many more.

The logical partitions may be termed “buckets” for storing data objects. Each bucket is replicated such that there are usually at least Q copies of a particular bucket available to the storage subsystem, e.g. bucket 114a is a replica of bucket 14. The location of a copy of a bucket can be determined by maintaining a lookup table 17 that lists the current buckets and their associated identifier ranges. As shown in FIG. 1, a copy of the lookup table 17 is stored on each client application 18 (any component, e.g. server, making use of the storage subsystem). The lookup table is local to each client application and each lookup table is an independent copy of the lookup tables on other applications, in other words there is no shared data. Alternatively, the lookup table may be stored centrally but this requires a separate reliable solution for achieving the fault tolerance of this data. There may be a plurality of client applications 18 which are connected to the storage subsystem 22. The communication between the client applications 18 and data store 22 may be achieved by any convenient mechanism.

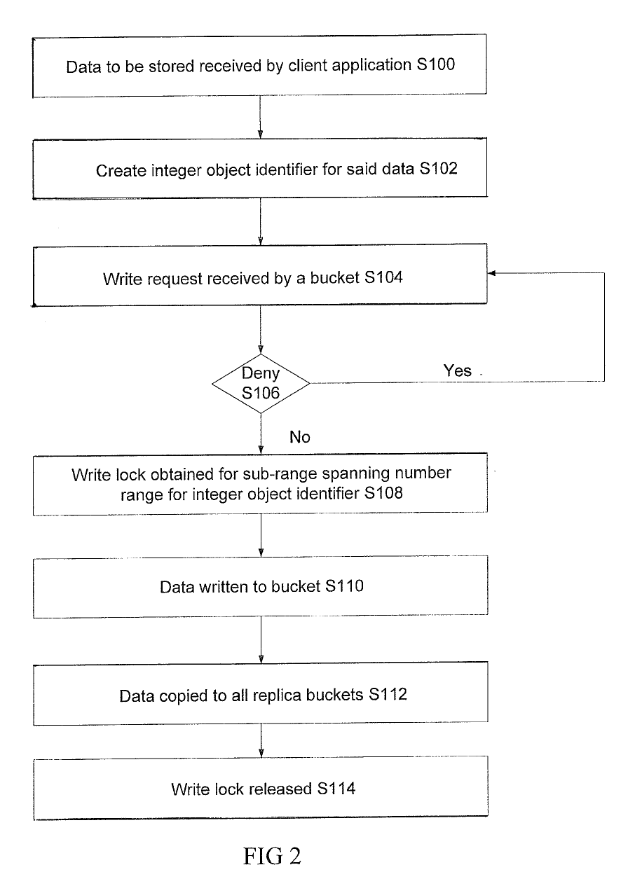

FIG. 2 shows how data is input (i.e. stored or written) in the system of FIG. 1. At step S100, a file (e.g. tree.jpg) or other data is received by the client application to be stored. At step S102, an integer object identifier for that data is created using a suitable hashing function of, for example, the objects application-specific filename (e.g. tree.jpg becomes 12034). The integer identifier described is not the only type of identifier for which this scheme can be implemented. Any identifier system where ranges of identifiers can be specified will suffice which typically also implies the identifiers are sortable.

Each bucket is responsible for a sequential range of integer object identifiers, e.g. 0-9999, 10000-19999 etc. The identifiers used to determine which bucket an object is within do not have to be unique across all objects in the system. If more than one object has the same identifier then all such objects will reside in the same bucket and additional means of specifying which object is actually being referred to will be required (e.g. by passing a normal filename along with the integer identifier).

To handle Write requests and maintain the synchronisation of the replicas of a bucket, the range of a bucket is divided up into sub-ranges. At step S104 a write request is sent from the client application and received at the appropriate bucket. At step S106, the write request is denied by the bucket (as explained in more detail below). Thus, the write request is sent to another bucket and step S104 is repeated. If this request is also denied, the system will loop until the write request is allowed and proceeds to step S108, where a write-lock is obtained and used to protect access to the relevant sub-range, i.e. the sub-range including the integer object identifier. At step S110, the data is written to the bucket and at step S112 it is copied to the plurality of replica buckets which are also responsible for the appropriate range, e.g. 12000-12999. The write lock is then released at step S114. In this way, there is no need for the client application to perform write requests to each any every replica bucket.

The bucket which is selected by the client application and which receives the original integer object identifier may be regarded as the master bucket and the replica buckets which receive copies may be regarded as slaves. The client application maintains knowledge of which is the master bucket. If the client application sends a write request to the wrong bucket, the write request is denied and an error message is returned to the client application with the details of the master bucket. The client application then resends the write request to the master bucket. Any bucket may act as a master bucket but only one bucket may be master at any one time. Communication between buckets is by any standard mechanism. It is noted that a bucket may contain zero or more stored objects, depending on whether any objects have been stored with an identifier falling within that buckets range.

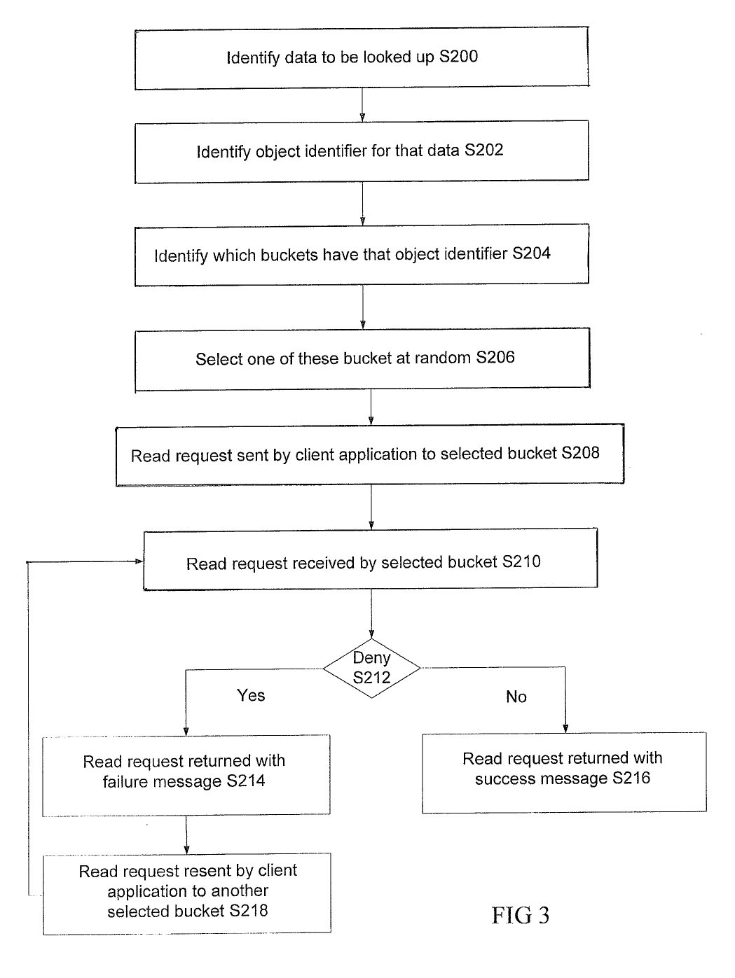

FIG. 3 shows how data is output (i.e. accessed or read) in the system of FIG. 1. At step S200, a client application identifies the data to be accessed from the data storage system. The client application calculates or otherwise identifies the object identifier for that data at step S202. Using the lookup table, the client application identifies which buckets hold the range of object identifier including the calculated object identifier at step S204. At step S206, the client application selects one at random and a read request for the data is sent from the client application and received at the selected bucket holding this information at step S208. As for other known storage solutions, read requests are distributed randomly between the replicas of the relevant bucket responsible for the range encompassing the particular object identifier. This helps with balancing the system load on each storage node. At step S210, the bucket receives the read request and determines whether or not the read request should be denied at step S212 (see below for more information). If the request is not denied, at step S216, the read request is returned with a success code. Otherwise, the request is denied and at step S214, the read request is returned with a failure code. The read request is resent from the client application at step S218 to an alternative bucket identified at step S204. The system loops until a success code is returned with the data. Read requests always return immediately with a success or failure code and are not delayed (blocked) or failed by any write-locks that may be in effect.

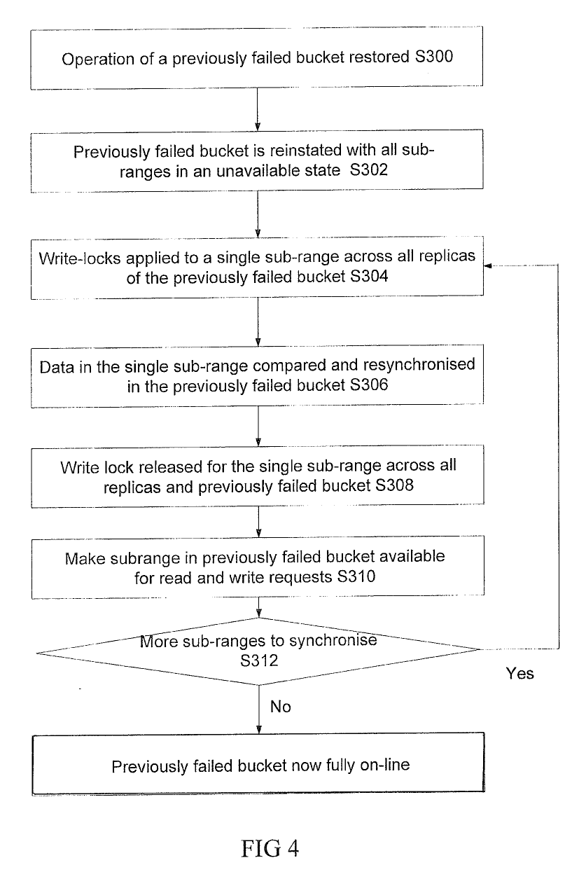

The use of a write-lock is similar to other storage solutions using either fine-grained or a more coarse-grained locking solution. The use of a write-lock is applicable to both blocking-I/O uses and nonblocking-I/O uses (which simply affects whether a write request is delayed (blocked) or denied (failed) when occurring before a previous write request to the same subrange has completed). In other words, a write-lock may be applied as explained with reference to FIG. 4 in the event of a failure or as described at Step S108 of FIG. 2, when a previous write request to the same sub-range has been received.

The main benefit to using sub-ranges within a bucket is for use in recovering from a failure situation which is illustrated in FIG. 4. If a bucket fails for either software or hardware reasons, it may become out-of-date with respect to the other replicas of that bucket as the other replicas receive and complete further write requests. At step S300, the operation of a previous failed bucket is restored and the storage subsystem begins the recovery process by assuming the data in the previous failed bucket is out-of-date. At step S302, this out-of-date bucket is brought up with all its subranges in an “unavailable” state so that any read and write requests that arrive at the bucket are denied by the bucket. This is similar to establishing read and write-locks to all sub-ranges in the previously failed bucket. The client application (or a software layer managing access to this storage system) is left to try a different replica as explained in relation to FIGS. 2 and 3. The storage subsystem then proceeds to consider each sub-range individually.

At step S304, a write-lock is obtained for a single sub-range of the previously failed bucket and for that sub-range across all replicas. At step S306, the state of the data in the sub-range in the previously failed bucket is compared and re-synchronised if necessary. At step S308, the write-lock is released for this sub-range for all buckets, including the previously failed bucket. Thus at step S310, this sub-range in the previously failed bucket is made available for read and write requests. At step S312, the system determines whether or not there are any additional sub-ranges to be synchronized and if so, loops through steps S304 to S312. In this way, the sub-ranges of a bucket are each brought back into active service (made online) one-by-one, thereby incrementally bringing the whole bucket back online. Any read or write requests that arrive at the bucket for an online sub-range are carried out, and any read or write requests for a still offline sub-range are denied.

This scheme therefore permits the recovery of a partition of data (bucket) without the need to implement a snapshot-journal-replay solution. Instead, recovery of partitions can happen during full live service and the necessary locking is made fine-grained to minimise the system impact to continued write-requests. Further, because the recovering bucket is incrementally made available, it begins to support the system load (particularly read requests that only need be handled by a single replica) as soon as the (potentially time consuming) recovery process has begun.

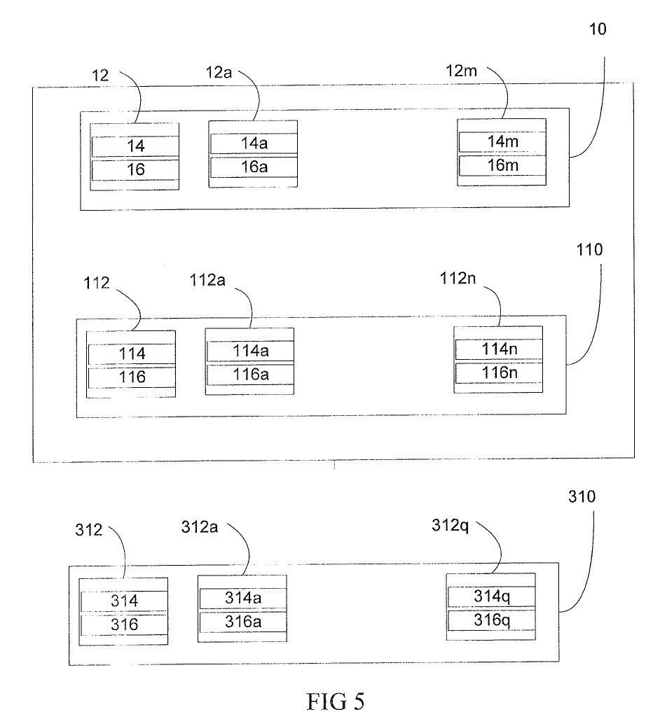

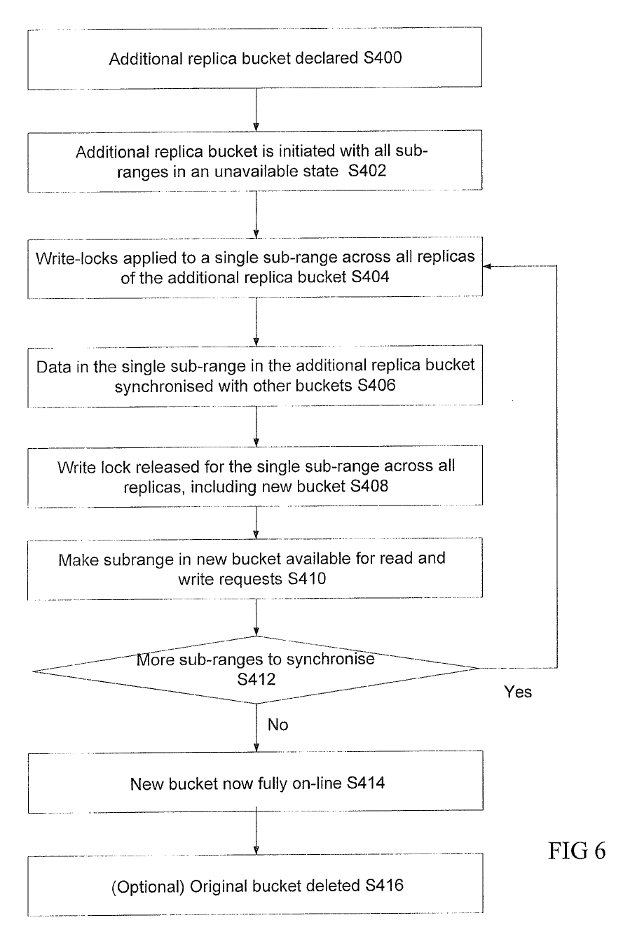

As shown in FIGS. 5 and 6, the same recovery process can also be used to migrate buckets from one location in the system to another, e.g. from one machine that is becoming full to another currently empty machine. FIG. 5 shows a storage system comprising two server computers 10, 110 each containing a plurality of disks (12, 12a, . . . 12m), (112, 112a, . . . , 1112n). Each disk hosts a plurality of logical partitions (14, 16), (14a, 16a), (14m, 16m), (114, 116), (114a, 116a), (114n, 116n). A third server computer 310 also containing a plurality of disks 312, 312a, . . . , 312q with logical partitions (314, 316), (314a, 316a), (314m, 316q) is to be added to the system. This can be achieved as set out in FIG. 6. At step S400, one or more additional replicas for the buckets of a near-full machine are declared on the new machines. At step S402, any read and write requests that arrive at these new replicas are denied by the bucket by initiating the bucket in an “unavailable” state. The client application (or a software layer managing access to this storage system) is left to try a different replica as explained in relation to FIGS. 2 and 3. The storage system then proceeds to consider each sub-range individually.

At step S404, a write-lock is obtained for a single sub-range of the new replica bucket and for that sub-range across all copies on the existing machines and any other new replicas already created on the new machine. At step S406, the data in the sub-range in the new replica bucket is synchronised with the existing buckets. At step S408, the write-lock is released for this sub-range for all buckets, including the new replica bucket. Thus at step S410, this sub-range in the new replica bucket is made available for read and write requests. At step S412, the system determines whether or not there are any additional sub-ranges to be synchronized and if so, loops through steps S404 to S412. The process thus populates the new replicas by treating them as completely out-of-date and synchronising each sub-range in turn until the replica bucket is fully online at step S414. Once the new replicas have been made, the replicas residing on the near-full machines can be taken offline and deleted as at optional step S416. Again, the pattern of sequentially locking each sub-range in turn avoids the need to implement a more heavy-weight snapshot-journal-replay solution whilst still maintaining full system availability.

In each embodiment, the number of sub-ranges (and therefore the data storage size associated with each sub-range) is configurable and tuned to make an optimal compromise between the speed of bucket recover/data migration versus the length of time any one sub-range is blocked. The larger the data stored in a sub-range, the longer that sub-range will take to resynchronise and therefore the longer any pending write-requests will have to be blocked. The sub-range sizing to select depends on many factors including the performance characteristics of the disk hardware, network and server processors. Merely as an example, recovery of a whole bucket of say 10 Mb may take one minute or longer but by using appropriately sized sub-ranges, of say 200 small files or 1 Mb, blocking of read/write requests for each sub-range may be reduced to milliseconds.

Similarly, in each embodiment, the distribution of sub-ranges within a range can be uniform or non-uniform and the sub-range pattern used in one bucket does not need to match the pattern used by a different bucket. The only constraint is that the sub-ranges between bucket replicas are identical to allow for consistent locking of these sub-ranges for write and recovery operations. The size of sub-ranges can be modified dynamically if suitable support is implemented to synchronise these changes across the replicas of a bucket. Such resizing can be used to maintain a reasonably constant amount of data stored within each sub-range—otherwise, the system will depend on the uniform distribution of object identifiers to keep the number of objects (and their total size) similar across all sub-ranges. It is desirable to keep the data size associated with each sub-range similar, or at least capped to a tunable maximum in order to guarantee a maximum block time during write or recovery operations.

There are many topologies for deploying this arrangement of storage components. The minimum system that still provides for fault-resilience requires a single machine with two disks, each disk storing a single bucket consisting of a single sub-range. However, this minimum configuration becomes equivalent to a simple mirrored disk solution such as RAID-0 (although with different recovery algorithms). The real benefit to this arrangement is realised when the data stored per disk is large such that it takes non-trivial time to copy an entire disk between machines, and when the total data capacity of the storage subsystem requires multiple disks on multiple machines. Further, the number of replicas of each bucket (partition) does not need to be consistent across the system, the only constraint is the system maintains knowledge of how many (and where) replicas are for each bucket. The size of each bucket can also vary and does not need a system-defined limit. Multiple buckets can share the same physical storage medium (e.g. hard disk partition) and grow until their total size reaches the capacity of the physical storage.

The storage mechanism used within each bucket may be any suitable mechanism. The requirement is that an object can be created, updated and read from. The simple underlying storage requirements also mean that no specialised storage formatting is required. This scheme can be layered on top of any file system or database allowing for the, preferably convenient, copying of objects or collections of objects. These simple requirements also mean that no meta-data about each sub-range needs to be stored (and synchronised) other than the current object identifier range limits that each sub-range is responsible for. However, this lack of meta-data requires that every sub-range is at least considered for resynchronisation during recovery which is an operation that might take considerable time. This time is not necessarily a problem as the system is still serving client requests while the recovery proceeds (potentially slowly) in the background.

If recovery time and network load are important factors to minimise then there are useful optimisations to be made if additional meta-data is stored per subrange such as the modification time or a modification sequence number. When such modification information is available, the copy operations required to resynchronise a bucket can be limited to copying only the data in the sub-ranges that have changed since a bucket replica failed.

A convenient means to arrange this modification information is to maintain, per bucket (and its replicas), an operation sequence number. This number is incremented on every update operation (write or delete request), and stored in the meta data (on each replica) of the relevant sub-range. In this way each replica of each sub-range knows the operation number that last modified it. When a bucket replica has been offline and needs to be restored, it can compare its last operation sequence number with the latest operation numbers of its other replicas, and only needs to copy the sub-ranges from a surviving bucket that have operation numbers between the recovering replica's last number and the number a surviving replica has got to.

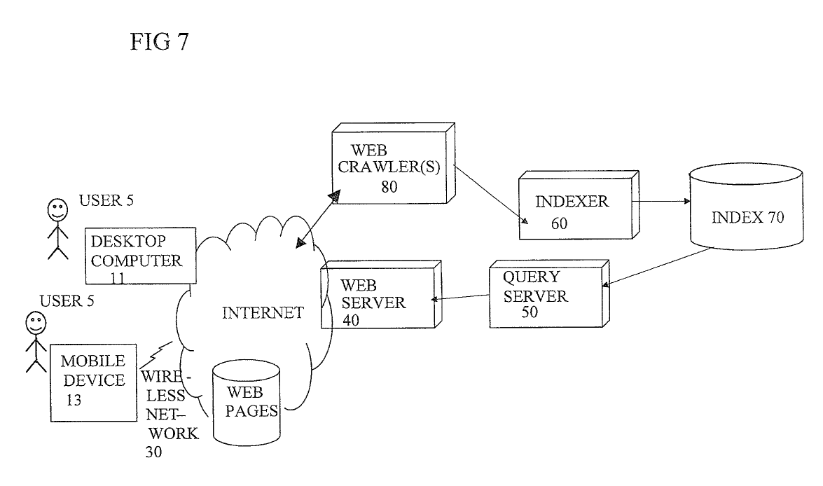

Mobile devices that are capable of accessing content on the world wide web are becoming increasingly numerous. Some of the problems of known mobile search services are addressed in US 2007/00278329, US 2007/0067267, US 2007/0067304, US 2007/0067305 and US2007/0208704 to the present applicants and the contents of these applications are herein incorporated by reference. The overall topology of such a system is illustrated in FIG. 7 which shows a mobile search service deployed using the normal components of a search engine. The search engine service is deployed using the query server 50 to prompt for and respond to queries from users. The indexer 60 populates the index 70 containing word occurrence lists (commonly referred to as inverted word lists) together with other meta-data relevant to scoring. The back-end crawler 80 scans for and downloads candidate content (“documents”) from web pages on the internet (or other source of indexable information). A plurality of users 5 connected to the Internet via desktop computers 11 or mobile devices 13 can make searches via the query server. The users making searches (‘mobile users’) on mobile devices are connected to a wireless network 20 managed by a network operator, which is in turn connected to the Internet 30 via a WAP gateway, IP router or other similar device (not shown explicitly). The connection to the query server 50 is made via a web server 40.

The search results sent to the users by the query server can be tailored to preferences of the user or to characteristics of their device. When conducting a search, the indexer builds a database of documents of numerous different types, e.g. images, music files, restaurant reviews, Wikipedia™ pages. For each type of document, various score data is also obtained using type-specific methods, e.g. restaurant reviews documents might have user supplied ratings, web pages have traffic and link-related metrics, music links often have play counts etc. Each of the above storage systems may be used to create, modify or otherwise maintain a database of searched material for use in such mobile search services.

A mobile device may be any kind of mobile computing device, including laptop and hand held computers, portable music players, portable multimedia players, mobile phones. Users can use mobile devices such as phone-like handsets communicating over a wireless network, or any kind of wirelessly-connected mobile devices including PDAs, notepads, point-of-sale terminals, laptops etc. Each device typically comprises one or more CPUs, memory, I/O devices such as keypad, keyboard, microphone, touchscreen, a display and a wireless network radio interface. These devices can typically run web browsers or microbrowser applications e.g. Openwave™, Access™, Opera™ Mozilla™ browsers, which can access web pages across the Internet. These may be normal HTML web pages, or they may be pages formatted specifically for mobile devices using various subsets and variants of HTML, including cHTML, WML, DHTML, XHTML, XHTML Basic and XHTML Mobile Profile. The browsers allow the users to click on hyperlinks within web pages which contain URLs (uniform resource locators) which direct the browser to retrieve a new web page.

Such mobile search services may also comprise a database that stores detailed device profile information on mobile devices and desktop devices, including information on the device screen size, device capabilities and in particular the capabilities of the browser or microbrowser running on that device. Such a database may also be created, modified or otherwise maintained as described above.

The client applications and servers can be implemented using standard hardware. The hardware components of any server typically include: a central processing unit (CPU), an Input/Output (I/O) Controller, a system power and clock source; display driver; RAM; ROM; and a hard disk drive. A network interface provides connection to a computer network such as Ethernet, TCP/IP or other popular protocol network interfaces. The functionality may be embodied in software residing in computer-readable media (such as the hard drive, RAM, or ROM). A typical software hierarchy for the system can include a BIOS (Basic Input Output System) which is a set of low level computer hardware instructions, usually stored in ROM, for communications between an operating system, device driver(s) and hardware. Device drivers are hardware specific code used to communicate between the operating system and hardware peripherals. Applications are software applications written typically in C/C++, Java, assembler or equivalent which implement the desired functionality, running on top of and thus dependent on the operating system for interaction with other software code and hardware. The operating system loads after BIOS initializes, and controls and runs the hardware. Examples of operating systems include Linux™, Solaris™, UniX™, OSX™ Windows XP™ and equivalents.

Any of the additional features can be combined together and combined with any of the aspects. Other advantages will be apparent to those skilled in the art, especially over other prior art. No doubt many other effective alternatives will occur to the skilled person. It will be understood that the invention is not limited to the described embodiments and encompasses modifications apparent to those skilled in the art lying within the spirit and scope of the claims appended hereto.

1. A data storage system comprising
a plurality of storage devices, each storage device comprising
a plurality of storage nodes and each storage node comprising
a plurality of logical partitions such that there are at least Q copies of a particular logical partition in the storage system,
wherein each logical partition is divided into a plurality of sub-ranges which are individually lockable to both data input and data output whereby data in a particular logical partition is synchronisable sub-range by sub-range with the other copies of said particular logical partition.

2. A storage system according to claim 1, wherein there are an equal number of storage nodes on each storage device.

3. A storage system according to claim 1, wherein there are an equal number of logical partitions in each storage node.

4. A storage system according to claim 1, wherein data is stored in the system using an object identifier for said data and each logical partion stores a sequential range of object identifiers.

5. A storage system according to claim 4, wherein the object identifier is an integer object identifier and each logical partion stores a sequential range of integer object identifiers.

6. A storage system according to claim 1, wherein the number of sub-ranges is configurable to balance speed of data recovery in a failed logical partition against length of time any one sub-range is locked.

7. A storage system according to claim 6, wherein the sub-range sizing depends on many factors including performance characteristics of the storage nodes and storage devices.

8. A storage system according to claim 1, wherein the sub-ranges are uniformly sized and distributed within a logical partition.

9. A storage system according to claim 1, wherein the sub-ranges used in said at least Q copies of each logical partition are identical to each other but differ from at least some of the sub-ranges used in other logical partitions.

10. A storage system according to claim 1, wherein the sub-ranges are dynamically modifiable.

11. A storage system according to claim 1, wherein said particular logical partition is a failed logical partition and whereby data is recoverable sub-range by sub-range in said failed logical partition from the other copies of the failed logical partition.

12. A data storage system comprising
a plurality of storage devices, each storage device comprising
a plurality of storage nodes and each storage node comprising
a plurality of logical partitions such that there are at least Q copies of a particular logical partition in the storage system,
wherein each logical partition is divided into a plurality of sub-ranges which are individually lockable to both data input and data output whereby in the event of a failure of a logical partition, data is recoverable sub-range by sub-range in said failed logical partition from said copies of the failed logical partition.

13. A storage system according to claim 1, comprising a further storage device having a plurality of storage nodes with a plurality of logical partitions to which data has been migrated sub-range by sub-range from corresponding logical partitions.

14. A data storage system comprising
a plurality of storage devices, each storage device comprising
a plurality of storage nodes and each storage node comprising
a plurality of logical partitions such that there are at least Q copies of a particular logical partition in the storage system, and
at least one further storage device having a plurality of storage nodes with a plurality of logical partitions,
wherein each logical partition is divided into a plurality of sub-ranges which are individually lockable to both data input and data output whereby data is synchronisable sub-range by sub-range between a logical partition in the at least one further storage device and corresponding copy logical partitions in the plurality of storage devices.

15. A system for a user to store and retrieve data, said system comprising
a storage system as claimed in any preceding claim and
at least one user device connected to the storage system whereby
when data is to be stored on the storage system said at least one user device is configured to input said data to an appropriate logical partition on said storage system and said storage system is configured to copy said data to all copies of said appropriate logical partition, and
when data is to be retrieved on the storage system said at least one user device is configured to send a request to at least of the logical partitions storing said data to output said data from the storage system to the user device.

16. A system according to claim 15, wherein the user device is configured to access a database storing information on all logical partitions to determine which logical partition is the appropriate logical partition in which to store data and from which to request data.

17. A system according to claim 16, wherein the database is stored on the user device.

18. A method of maintaining a fault-tolerant data storage system comprising
providing a data storage system comprising
a plurality of storage devices, each storage device comprising
a plurality of storage nodes and each storage node comprising
a plurality of logical partitions,
configuring the plurality of logical partitions so that there are at least Q copies of any logical partition in the storage system,
dividing each logical partition into a plurality of sub-ranges which are individually lockable to both data input and data output, whereby data in a particular logical partition is synchronisable sub-range by sub-range with the other copies of said particular logical partition.

19. A method according to claim 18, comprising
inputting, into a first logical partition, data to be stored from a user device, and
copying said inputted data to a plurality of logical partitions so that there are said at least Q copies of the first logical partition.

20. A method according to claim 18, comprising creating an object identifier for said data and storing said object identifier.

21. A method according to claim 20, comprising creating an object identifier in the form of an integer object identifier for said data.

22. A method according to claim 18, comprising recovering data in a previously failed logical partition.

23. A method according to claim 22, comprising recovering data sub-range by sub-range by
making unavailable all sub-ranges of said previously failed logical partition,
selecting a single sub-range to be synchronised,
locking said selected single sub-range in all copies of said previously failed logical partition,
synchronising data in said single sub-range of said previously failed logical partition with said single sub-range in all copies of said previously failed logical partition,
unlocking said selected single sub-range in all copies of said previously failed logical partition, including said previously failed logical partition and
repeating the selecting to unlocking steps until all sub-ranges are unlocked.

24. A method according to claim 18, comprising increasing storage capacity by
providing a further storage device having a plurality of storage nodes, each comprising a plurality of logical partitions,
defining a logical partition in said further storage device to be a copy of a logical partition on the plurality of storage devices and
migrating data in the logical partition on the plurality of storage devices to the defined logical partition in said further storage device.

25. A method according to claim 24, comprising migrating data by
making unavailable all sub-ranges of said defined logical partition in said further storage device,
selecting a single sub-range to be synchronised,
locking said selected single sub-range in all copies of said defined logical partition,
synchronising data in said single sub-range of said defined logical partition with said single sub-range in all copies of said defined logical partition,
unlocking said selected single sub-range in all copies of said defined logical partition, including said defined logical partition and
repeating the selecting to unlocking steps until all sub-ranges are unlocked.

26. A method of data recovery in a fault-tolerant storage system, said data storage system comprising a plurality of storage devices, each storage device comprising a plurality of storage nodes and each storage node comprising a plurality of logical partitions such that there are at least Q copies of any logical partition in the storage system and each logical partition is divided into a plurality of sub-ranges which are individually lockable to both data input and data output, the method comprising
making unavailable all sub-ranges of a failed logical partition,
selecting a single sub-range of the failed logical partition to be synchronised,
locking said selected single sub-range in all copies of said failed logical partition,
synchronising data in said single sub-range of said failed logical partition with said single sub-range in all copies of said failed logical partition,
unlocking said selected single sub-range in all copies of said failed logical partition, including said failed logical partition and
repeating the selecting to unlocking steps until all sub-ranges are synchronised and unlocked.

27. A method of increasing data storage in a fault-tolerant storage system comprising a plurality of storage devices, each storage device comprising a plurality of storage nodes and each storage node comprising a plurality of logical partitions such that there are at least Q copies of any logical partition in the storage system and each logical partition is divided into a plurality of sub-ranges which are individually lockable to both data input and data output, the method comprising
making unavailable all sub-ranges of said defined logical partition in said further storage device,
selecting a single sub-range to be synchronised,
locking said selected single sub-range in all copies of said defined logical partition,
synchronising data in said single sub-range of said defined logical partition with said single sub-range in all copies of said defined logical partition,
unlocking said selected single sub-range in all copies of said defined logical partition, including said defined logical partition and
repeating the selecting to unlocking steps until all sub-ranges are unlocked.

28. A carrier carrying computer program code to, when running, implementing the method of claim 27.
